(19) United States
(12) Patent Application Publication
(10) Pub. No.: US 2006/0096439 A1
(43) Pub. Date: May 11, 2006

(54) Logo guitar

(76) Inventor: William D. McPherson, Dartmouth (CA)

Correspondence Address: ANTONY C. EDWARDS, SUITE 200 - 270 HIGHWAY 33 WEST, KELOWNA, BC, V1X 1X7, CA

(21) Appl. No.: 11/267,405

(22) Filed: Nov. 7, 2005

Related U.S. Application Data
(60) Provisional application No. 60/625,136, filed on Nov. 5, 2004.

(51) Int. Cl. G10D 3/00

(52) U.S. Cl. 84/290

(57) ABSTRACT

A guitar body made in the likeness of a logo of a sports team. The logo on the guitar is converted from an original logo by scaling the logo to accommodate the size and shape required to make a functional guitar body in the shape of the logo.

### CROSS REFERENCE TO RELATED APPLICATION

This application claims priority from U.S. Provisional Patent Application No. 60/625,136 filed Nov. 5, 2004 entitled Logo Guitar.

### FIELD OF THE INVENTION

This invention relates to guitars and in particular guitar bodies made in the likeness of logos' of sports teams and other logo representations, and a method of producing the same. These guitars are typically electrical guitars or guitars that do not rely on the acoustics of a resonant cavity, but are not limited to non-acoustic guitars.

### BACKGROUND OF THE INVENTION

It is known that likenesses of guitars have been incorporated into logos and promotional marketing materials such as pins and other items like the “Hard Rock Café”, “Rams”, and “Philadelphia Flyers” logo guitar pins. It is also known that guitar bodies can be made in many shapes and forms, some of which have become logo forms after their creation as in the case of the “Queensryche Logo Guitar; the guitar became the band's logo.

The Twisted Sister signature guitar simply had a bulls eye painted on a regular body shape guitar, which is not the Twisted Sister logo. Similarly the People Soft logo guitar was a regular body shape guitar with the “Stylized” People Soft painted on the front surface of it, with no modification of the guitar body shape. Similarly the “Cheap Trick” logo guitar is a regular shaped guitar body with a checker board pattern painted on the front surface, similar to the checkerboard pattern of the “Cheap Trick” logo, with no modification of the guitar body shape. Eric Bloom's logo guitars are for the majority regular shaped guitars with artwork or logos painted on them. The one exception to this is the Renaldo Classic custom guitar made in the shape of the logo for the “Blue Oyster Cult.

The National Hot Rod Association (NHRA) themed guitars made by Jeff Cleavenger were more stylized bill boards with NHRA advertising on them, than logo shaped guitar bodies.

Applicant is aware of design patents representing different shapes of guitar bodies. However, none have been identified as resembling a known logo, and in particular a sports team logo.

### SUMMARY OF THE INVENTION

The present invention serves to create guitars and in particular guitar bodies made in the likeness of logos' of sports teams. The method of producing a logo guitar involves conversion of the original logo by scaling to accommodate the size and shape required to make a functional guitar body in the shape of the logo. Some shapes require the addition of material outside of the logo to accommodate the components of the guitar for example an electric guitar, generally below the logo for volume and tone control, and pickup switching. The guitar body is generally cut and constructed in the shape of the converted logo from wood, laminated wood, or other suitable material of appropriate thickness or machined or molded into shape or otherwise formed, and then finished by applying artwork, neck, bridges, strings and in the case of electric guitars pickups, controls, strings. The graphics of the logo is thus applied or later applied. For example, the logo may be either painted, screened or applied using a decal with a protective overlay finish.

In summary, the present invention may be characterized in one aspect as a guitar, and a method of making same, wherein at least the body of the guitar is shaped to resemble a three-dimensional representation of at least a portion of a team logo, and wherein the at least a portion of the team logo is dimensionally modified from original proportions of the team logo so as to be adapted for use as the body of the guitar. In a preferred embodiment, the body is dimensionally modified by scaling of a height dimension of the logo and a length dimension of the logo according to corresponding height dimension and length dimension scale factors so as to adapt the body for use as the body of the guitar. The length dimension is measured substantially parallel to the neck of the guitar. The height dimension is measured perpendicular to the length dimension in a plane containing the body of the guitar.

In a further aspect, the present invention may include modification of the dimensions of the body of the guitar according to a ratio of the height dimension scale factor divided by the length dimension scale factor, wherein the ratio may be within the range of substantially 0.75-1.5. The recognizability of the logo is thus maintained.

In exemplary embodiments, not intended to be limiting, the logo may comprise a stylized face design wherein the face design may appear to be looking in a direction towards the neck of the guitar, or the body of the guitar may be formed so as to include a stylized letter of the alphabet, wherein the letter outlines a substantial portion of a circumference of the body.

In addition, the logo may extend along the neck of the guitar so that the neck of the guitar is formed as a part of the logo along at least a portion of the neck. The body may also be formed so as to include an additional mass portion extending from the portion of the body depicting the logo. The guitar controls may be mounted on the additional mass portion, and the additional mass portion may extend from a lower edge of the logo. Preferably, the logo is oriented for viewing when the neck of the guitar is substantially horizontal and the body is oriented substantially vertically as when the guitar is being worn by a musician during use of the guitar.

In preferred embodiments, the logo may depict a logo from a national football league team, or a logo from a national hockey league team, or a logo from a sports team chosen from the group comprising: professional teams, semi-professional teams, or amateur teams such as university teams.

### BRIEF DESCRIPTION OF THE DRAWINGS

FIG. 1 is, in front perspective view, a logo guitar according to the present invention made in the likeness of the “New England Patriots” football team logo.

FIG. 2 is, in front elevation view, the body of the “New England Patriots” logo guitar showing relative dimensions and component placement.

FIG. 3 is, in front elevation view the original logo of the “New England Patriots” prior to conversion of proportions for manufacture of the logo guitar.

FIG. 4 is, in front elevation view a template for the placement of the neck, bridge, and pickups to be applied to a logo guitar body.

FIG. 5, is in front perspective view, a logo guitar in the likeness of the “Calgary Flames” hockey team logo.

FIG. 6 is, in front elevation view, the body of the “Calgary Flames” logo guitar showing relative dimensions and component placement.

FIG. 7 is, in front elevation view the original logo of the “Calgary Flames” prior to conversion of proportions for manufacture of the logo guitar.

FIG. 8 is, in front elevation view, the body of the “Detroit Redwings” logo guitar showing relative dimensions and component placement.

FIG. 8a is an alternative embodiment of a logo guitar according to the present invention.

FIG. 9 is, in normal view, the original logo of the “Detroit Redwings” hockey team prior to conversion of proportions for manufacture of the logo guitar.

FIG. 10, is in front elevation view, the body of the “Atlanta Falcons” logo guitar showing relative dimensions and component placement.

FIG. 11, is in front elevation view, the original logo of the “Atlanta Falcons” football team prior to conversion of proportions for manufacture of the logo guitar.

### DETAILED DESCRIPTION OF EMBODIMENTS OF THE INVENTION

The present invention is a logo guitar having a body in the likeness of a logo or at least a portion thereof. The present invention is also a method for forming logo guitars and in particular guitar bodies made in the likeness of logos' of sports teams and other logo representations (collectively herein referred to as representations).

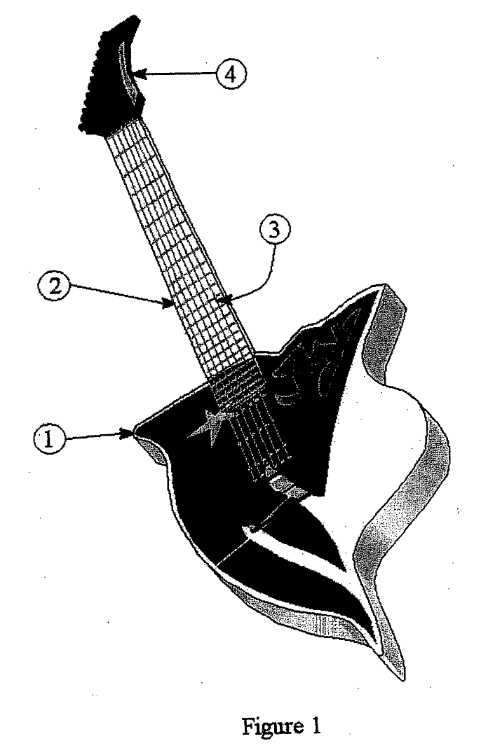

FIG. 1 illustrates one embodiment of the logo guitar in the form of the “New England Patriots” logo, consisting of the body 1, neck 2, and strings 3.

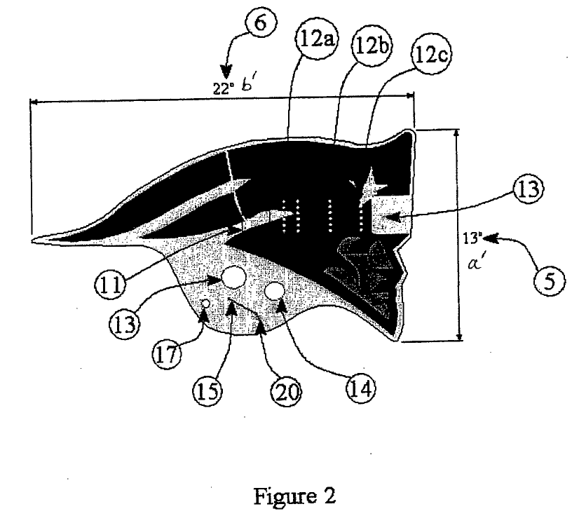

FIG. 2 shows the body of the same guitar showing the scaled height 5 (dimension a′), and scaled length 6 (dimension b′), including placement of the bridge 11, base pickup 12a, mid-range pickup 12b, high-end pickup 12c, neck mount 13, volume control 14, tone control 15, and toggle control 16, and guitar output 17. In order to ergonomically place the controls an additional mass of material 20 is added to, so as to depend from, the scaled outline of the logo. Additional mass of material 20 may be formed from the same material used to form or construct or mold the portion of the body 1 forming the logo. The addition of material 20 may not be required on all logo guitars depending on whether the shape of the logo naturally provides a convenient place to mount the guitar controls. Component placement is basic to electric guitars and is shown here only to resemble that of a conventional electric guitar. The placement of the controls is not intended to be limiting. It is expressly intended that the present invention may include acoustic guitars also.

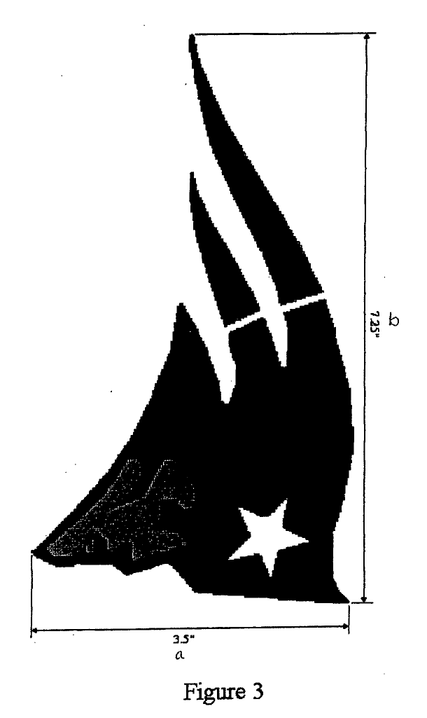

FIG. 3 shows the original logo of the “New England Patriots” with a relative height of three and one half inches (dimension a) and relative length of seven and one quarter inches (dimension b), which when converted to guitar dimensions would be as shown in FIG. 2 with a relative height of thirteen inches (dimension a′) and a relative length of twenty-two inches (dimension b′) after scaling dimension a to increase the height dimension 4 to 1, and scaling dimension b to increase the length dimension 3 to 1, from the original logo dimensions. Thus to form body 1, the logo is scaled 4:3 (height:length). This fits the logo into the basic parameters of a basic guitar, resulting in a somewhat different shape than the original logo, but resulting in a shape that is still recognizable as the original logo.

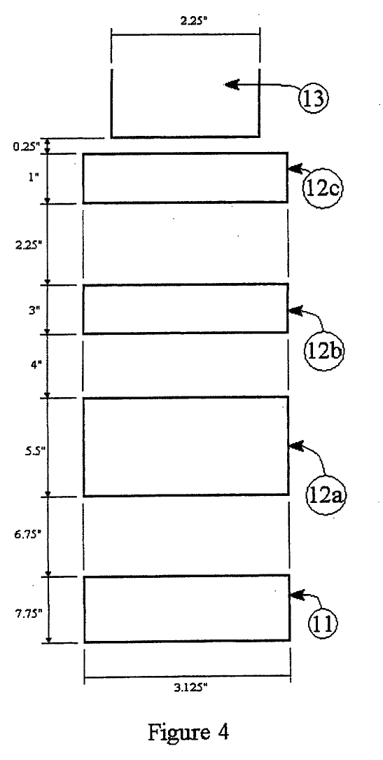

FIG. 4 shows a template used for component placement relative to the neck cutout or mounting position 13, and includes the high-end or neck pickup 12c, mid-range pickup 12b, the base, rhythm or bridge pickup 12a, and the bridge 11 cutout. This template may be used for most guitars independent of logo size and shape.

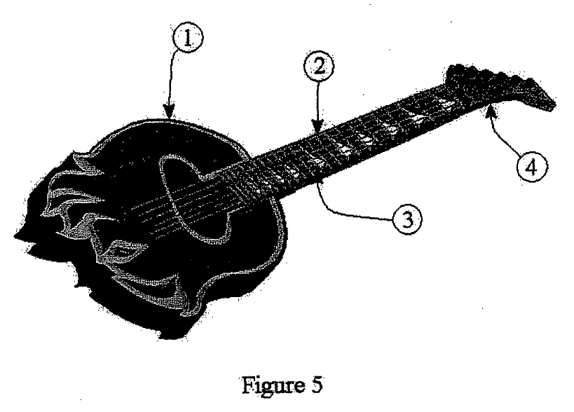

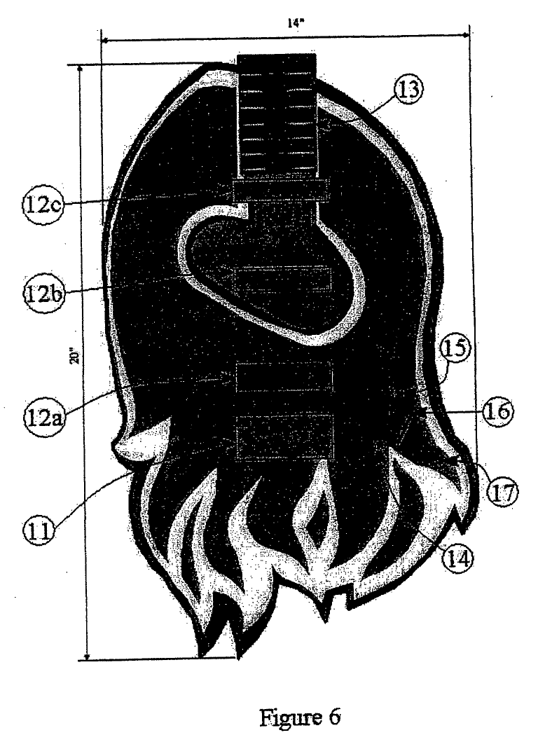

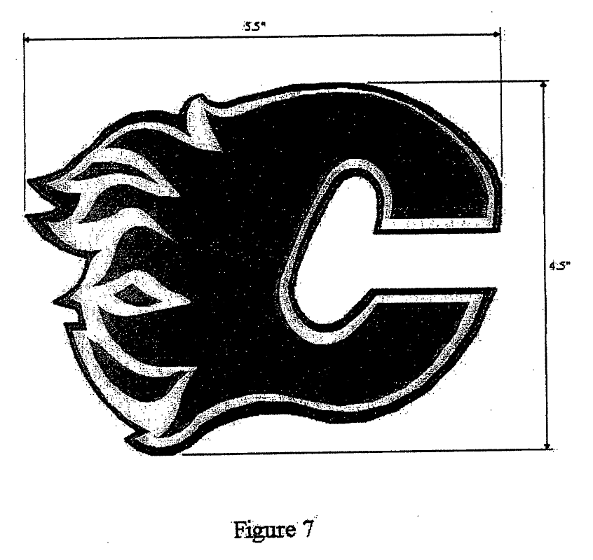

FIGS. 6 and 7 illustrate one embodiment of the logo guitar for the “Calgary Flames” logo in which the height of the original logo is scaled 3.11 to 1 while the length is scaled 3.64 to 1 (that is approximately scaled 3:3.5, height:length), creating a guitar body within the basic parameters of a basic guitar while maintaining the recognizability of the original logo, resulting in the finished logo guitar of FIG. 5.

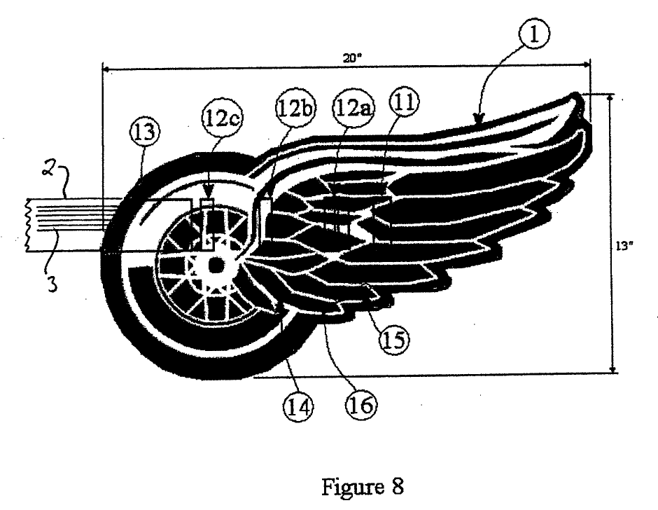

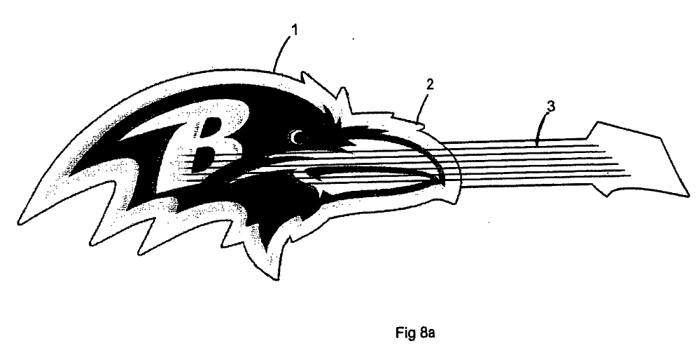

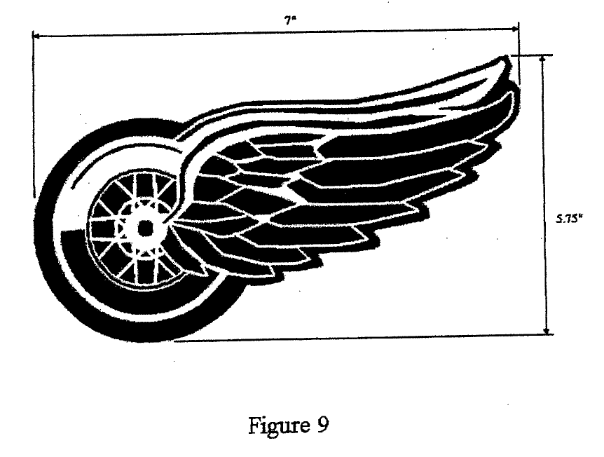

FIGS. 8 and 9 illustrate one embodiment of the logo guitar for the “Detroit Redwings” logo in which the height of the original logo is scaled 2.25 to 1 while the length is scaled 2.9 to 1 (that is approximately scaled 2.25:3, height:length), creating a guitar body within the basic parameters of a basic guitar while maintaining the recognizability of the original logo. FIG. 8a illustrates a logo guitar with the logo of the Baltimore Ravens so that part of the logo (the beak portion in this instance) form part of the neck of the guitar.

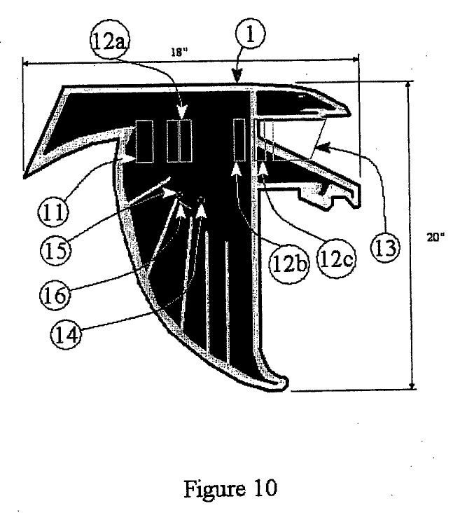

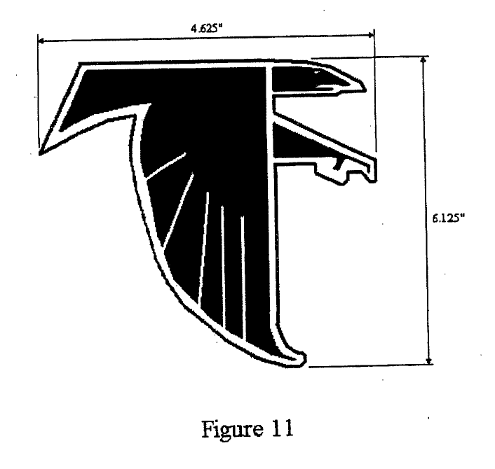

FIGS. 10 and 11 illustrate one embodiment of the logo guitar for the “Atlanta Falcons” logo in which the height of the original logo is scaled 3.5 to 1 while the length is scaled 4 to 1 (that is scaled 3.5:4, height:length), creating a guitar body within the basic parameters of a basic electric guitar while maintaining the recognizability of the original logo.

The method of producing a logo guitar involves conversion of the original logo by scaling to accommodate the size and shape required to make a functional guitar body in the shape of the logo. Generally the ratio of the two scale factors (height:length) applied to the height and length of the original logo may be constrained within a range of approximately 0.75 to 1.5 in order to maintain the recognizability of the logo, while creating a guitar body within the basic parameters of an electric guitar as summarized in the table below for the four logo types discussed examples of the present invention as above.

| | Height | Length | Ratio of |
|---|---|---|---|
| Logo | Scale Factor | Scale Factor | Scale Factors |
| New England Patriots | 4 | 3 | 1.33 |
| (FIG. 2) | | | |
| Calgary Flames | 3.11 | 3.64 | 0.85 |
| (FIG. 5) | | | |
| Detroit Redwings | 2.25 | 2.9 | 0.78 |
| (FIG. 8) | | | |
| Atlanta Falcons | 3.5 | 4 | 0.88 |
| (FIG. 10) | | | |

With regards to electric guitars, some shapes require the addition of an additional mass of material outside of the logo contour or circumference to accommodate the components of the guitar, generally below the logo, for tone and volume control, and pickup switching. The guitar body may be cut in the shape of the converted, that is scaled, logo from wood, laminated wood, or some other suitable material of appropriate thickness, and finished by applying artwork, pickups, controls, neck and strings. The graphics of the logo can be either painted, screened or applied using a decal with a protective overlay finish.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A guitar comprising a body and a neck, wherein at least said body is shaped to resemble a three-dimensional representation of at least a portion of a team logo, and wherein said at least a portion of said team logo is dimensionally modified from original proportions of said team logo so as to be adapted for use as said body of said guitar.

2. The guitar of claim 1 wherein said body is dimensionally modified by scaling of a height dimension of said logo and a length dimension of said logo according to corresponding height dimension and length dimension scale factors so as to adapt said body for said use as said body of said guitar wherein said length dimension is substantially parallel to said neck of said guitar and wherein said height dimension is perpendicular to said length dimension in a plane containing said body.

3. The guitar of claim 2 wherein the ratio of said height dimension scale factor and said length dimension scale factor is within the range of substantially 0.75-1.5, whereby recognizability of said logo is maintained.

4. The guitar of claim 2 wherein said logo comprises a stylized face design and wherein said face design appears to be looking in a direction towards said neck of said guitar.

5. The guitar of claim 2 wherein said body is formed so as to include a stylized letter of the alphabet, and wherein said letter outlines a substantial portion of a circumference of said body.

6. The guitar of claim 2 wherein said logo extends along said neck so that said neck of said guitar is formed as a part of said logo along at least a portion of said neck.

7. The guitar of claim 2 wherein said body is formed so as to include an additional mass portion extending from said portion of said body depicting said logo, and wherein guitar controls are mounted on said additional mass portion.

8. The guitar of claim 7 wherein said additional mass portion extends from a lower edge of said logo.

9. The guitar of claim 2 wherein said logo is oriented for viewing when said neck of said guitar is substantially horizontal and said body is oriented substantially vertically as when said guitar is being worn by a musician during use of said guitar.

10. The guitar of claim 2 wherein said logo depicts a logo from a national football league team.

11. The guitar of claim 2 wherein said logo depicts a logo from a national hockey league team.

12. The guitar of claim 2 wherein said logo depicts a logo from a sports team chosen from the group comprising: professional teams, semi-professional teams, or amateur teams.

13. The guitar of claim 2 wherein said logo depicts a team logo from a sports team chosen from the group comprising: NFL teams, NHL teams, university teams.

14. A method of making a guitar having a body and a neck, wherein the method includes the steps of:
a) dimensionally modifying at least a portion of a team logo from original proportions of said team logo so as to adapt said team logo for use as said body of said guitar; and,
b) shaping at least said body to resemble a three-dimensional representation of at least a portion of a team logo.

15. The method of claim 14 wherein said step of dimensionally modifying includes scaling of a height dimension of said logo and a length dimension of said logo according to corresponding height dimension and length dimension scale factors so as to adapt said body for said use as said body of said guitar wherein said length dimension is substantially parallel to said neck of said guitar and wherein said height dimension is perpendicular to said length dimension in a plane containing said body.

16. The method of claim 15 wherein said scaling is limited according to a ratio of said height dimension scale factor divided by said length dimension scale factor, and wherein said ratio is within the range of substantially 0.75-1.5 so as to maintain recognizability of said logo.

17. The method of claim 16 wherein said shaping step includes shaping said logo so as to extend said logo along said neck so that said neck of said guitar is formed as a part of said logo along at least a portion of said neck.

18. The method of claim 16 further comprising the step of forming said body so as to include an additional mass portion extending from said portion of said body depicting said logo.

19. The method of claim 16 further comprising the step of selecting said logo so as to depict a logo from a sports team chosen from the group comprising: professional teams, semi-professional teams, or amateur teams.

20. The method of claim 16 further comprising the step of selecting said logo so as to depict a team logo from a sports team chosen from the group comprising: NFL teams, NHL teams, university teams.
